(19) United States
(12) Patent Application Publication
(10) Pub. No.: US 2004/0000770 A1
(43) Pub. Date: Jan. 1, 2004

(54) One-sides sprung arm of a bicycle front wheel

(76) Inventor: Pavel P. Miksik, Brarislava (SK)

Correspondence Address: OPPEDAHL AND LARSON LLP, P O BOX 5068, DILLON, CO, 80435-5068, US

(21) Appl. No.: 10/362,275

(22) PCT Filed: Aug. 24, 2001
(86) PCT No.: PCT/SK01/00020

(30) Foreign Application Priority Data
Aug. 24, 2000 (SK) PV 1283-2000

(51) Int. Cl. B62K 1/00

(52) U.S. Cl. 280/278; 280/279

(57) ABSTRACT

A one-sided spring-loaded arm for the front wheel of a bicycle consists of two parts (1,2), of which one is springing, and further, one of them is adapted to attach the front wheel of a bicycle and the other is adapted to be attached to the handlebar system of the bicycle. Part (2), which is adapted to attach the front wheel, is joined with part (1) slidingly in the direction of the longitudinal axis of part (1), as well as pivotally around this axis with a position fixation, as well as tiltably, with the axis of tilt lying in a plane transverse to the longitudinal axis of part (1), which is adapted to be attached to the handlebar system of the bicycle. Part (1), which is adapted to be attached to the handlebar system of the bicycle, may be spring-loaded and it comprises a supporting part (1.1), on which there is an auxiliary member (2.2) arranged slidingly and pivotally and positionally fixably. Part (2), which is adapted to attach the front wheel of the bicycle, may be spring-loaded and it comprises a telescopic part (2.1), which is terminated with a pivotally arranged auxiliary member (2.2).

The present invention relates to a one-sided spring-loaded arm for the front wheel of a bicycle.

### BACKGROUND

At present there are only a few solutions which are concerned with folding the front wheel. There are solutions known which concern folding only in the region of the frame of a bicycle.

The patent DE 43 13 832 A1 is concerned with folding the front wheel of a folding bicycle. Here the front wheel is folded by means of a hinge, which is located at one of the fork arms. On the hinge there is a further auxiliary arm, to which the front wheel is attached. In the course of folding the upper part of the auxiliary arm with the wheel is detached from the supporting arm and turned around the hinge towards the back wheel. A disadvantage of this solution is that the wheel is attached to two arms, dimensions of the folded bicycle being too large in comparison with small wheel diameters.

The front wheel according to the patent B 62 K 15/00 A1 (International patent application publication number WO 85/01711) is folded into a case also using a hinge which is mounted on the front fork. After having detached an auxiliary fork the wheel is turned forward together with the auxiliary fork and then it is turned towards the back wheel together with the handlebars around the axis of the steering. The disadvantages are an ergonomically unsuitable solution of the bicycle, unsprung wheels, and large dimensions of the folded bicycle in comparison with small wheels of the bicycle.

The U.S. Pat. No. 4,830,133 solves the folding of a moped by tilting the front wheel in such a way that the whole front telescopic fork is tilted together with the wheel. The tilting is enabled by a pivot, which is located in the area of the upper mounting of the fork in the frame. After releasing a safety bolt, the wheel with the fork is detached and tilted backwards to the back wheel. A disadvantage of the solution consists in great dimensions of the folded moped despite its small wheels.

In U.S. Pat. No. 4,598,923 the bicycle is folded into a case. The front wheel is not spring-loaded and it is tilted together with the front fork around a pivot, which is located just under the head assembly at the axis of the steering. After releasing the pivot, the fork together with the wheel is tilted to the back wheel. A disadvantage is again the great dimensions of the folded bicycle despite small wheels of the bicycle and, moreover, the bicycle has an unsprung wheel.

### SUMMARY

The present disadvantages are eliminated by a one-sided spring-loaded arm for the front wheel of a bicycle, the nature of which consists in that it consists of two parts (1) and (2), of which one is springing (spring-loaded or springy), and further, one of them is adapted to attach the front wheel of a bicycle and the other is adapted to be attached to the handlebar system of the bicycle. Part (2), which is adapted to attach the front wheel, is joined with part (1) slidingly in the direction of the longitudinal axis of this part (1) as well as pivotally around this axis. Part (2), which is adapted to attach the front wheel, is joined with part (1), which is adapted to be attached to the handlebar system of the bicycle, with a possibility to fix its position, as well as tiltably around an axis of tilt, which is lying in a plane transverse to the longitudinal axis of part (1), which is adapted to be attached to the handlebar system of the bicycle.

Part (2), which is adapted to attach the front wheel of a bicycle, comprises a telescopic part (2.1) and it may be springing. The telescopic part is terminated with a pivotally arranged auxiliary member (2.2). The telescopic part (2.1) and the auxiliary member (2.2) are slidingly and pivotally arranged and are positionally fixable in a longitudinal opening in part (1), which is adapted to be attached to the handlebar system of the bicycle.

Part (1), which is adapted to be attached to the handlebar system of the bicycle, comprises a supporting part (1.1) and it may be springing. On the supporting part (1.1), there is slidingly and pivotally arranged and positionally fixable an auxiliary member (2.2), which is tiltably and with positional fixation joined with part (2), which is adapted to attach the front wheel of the bicycle. The supporting part [(1.] [1)] is slidingly and pivotally and positionally fixable in part (2), which is adapted to attach the front wheel of the bicycle.

The tiltable connection between the auxiliary member (2.2) and part (2) of the fork, which is adapted to attach the front wheel of the bicycle, is positionally fixable.

It has been found that it is preferable if the rotatable part is mounted on one of the sides of the springing part, which is connected with the auxiliary member (2.2), and its distance from the longitudinal rotation axis of the front wheel is from 150 to 400 mm.

The springing part can be folded around the rotatable part to the lateral or back side of the non-springing part.

The rotatable part is preferably a pivot.

The main advantage of the one-sided spring-loaded arm of the front wheel of a bicycle consists in that it allows to fold the front wheel with a diameter from 300 to 800 mm. Such a solution of the one-sided spring-loaded arm of the front wheel of a bicycle is preferred especially for folding bicycles, which are described in PV 1621-99, according to which bicycles of any type, those from the bicycles for children to the bicycles for adults, also with classical wheel diameters, can be folded into a square, which represents the wheel diameter or the diameter of the wheel with a mudguard.

A further advantage of the object arm is the fact that folding the bicycle and its unfolding to the mobile condition is quick, simple, and it does require neither any expert knowledge nor any tools.

### DESCRIPTION OF THE DRAWING

Embodiments of the invention are shown in a Drawing in several Figures.

FIG. 1 shows a front view of the one-sided spring-loaded arm with a wheel, and FIG. 2 shows a side view of the one-sided spring-loaded arm with a wheel with an indication of the springing direction.

FIG. 3 shows a side view displaying the extended springing part, which is adapted to attach the front wheel, with the tilting direction indicated.

FIG. 4 shows a side view and FIG. 5 shows a front view of the tilted one-sided arm with the front wheel.

FIG. 6 shows a front view and FIG. 7 shows a side view of the one-sided arm with the springing part, which is adapted to be attached to the handlebar system of the bicycle and with the rotatable part mounted on its lateral side.

FIG. 8 shows the extended part, which is adapted to be attached to the handlebar system of the bicycle, with an auxiliary member and with the tilting direction around the rotatable member indicated, and FIG. 9 shows backward inserting the auxiliary member with the part, which is adapted to be attached to the handlebar system of the bicycle.

FIG. 10 shows a side view and FIG. 111 shows a front view of the folded one-sided arm with the front wheel of a bicycle.

FIG. 12 shows a side view and FIG. 13 shows a front view of a laterally folded one-sided arm with the attached front wheel.

FIG. 14 shows extension of the part, which is adapted to be attached to the handlebar system, with the auxiliary member of the bicycle and tilting the part, which is adapted to attach the front wheel, to the lateral side of the part, which is adapted to be attached to the handlebar system of the bicycle, and FIG. 15 shows is a rear view of insertion of the auxiliary member with the part, which is adapted to be attached to the handlebar system.

FIG. 16 shows a front view and FIG. 17 shows a side view of the one-sided arm with the front wheel attached.

### DETAILED DESCRIPTION

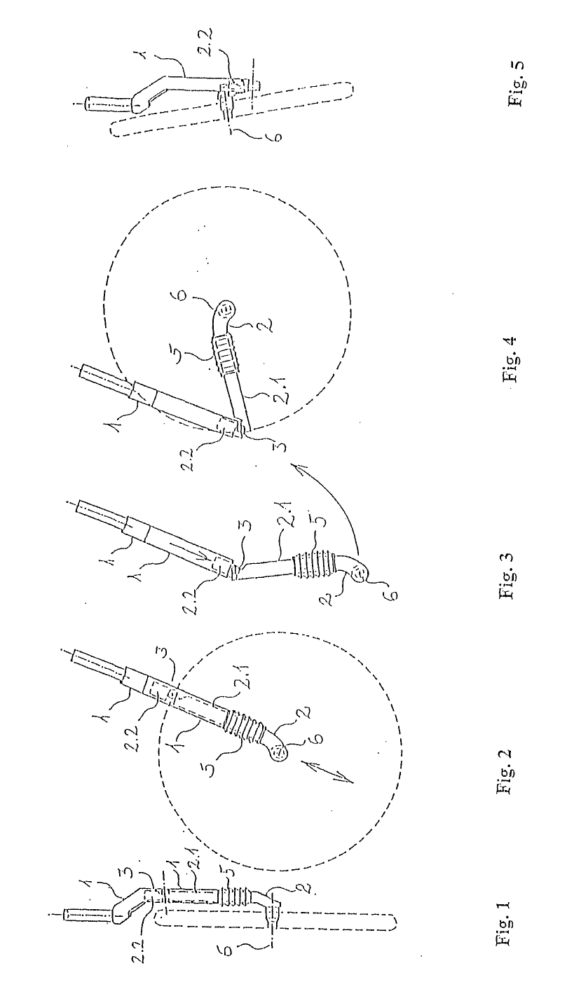

Example 1. A one-sided spring-loaded arm of the front wheel, which is shown in FIGS. 1 and 2, has a part (2) provided with a spring (5) and joined with the auxiliary member (2.2) by means of a pivot (3). A sliding part (2.1) of the springing part (2), which is adapted to attach the front wheel, is mounted in part (1), which is adapted to be attached to the handlebar system of the bicycle.

When folding the one-sided arm of the front wheel according to FIGS. 3 to 5, the auxiliary member (2.2) is slid out together with the sliding part (2.1) from part (1) downward, and in this position it is turned around the axis of the pivot (3) towards the rear side of part (1). When unfolding the arm, the procedure is reversed.

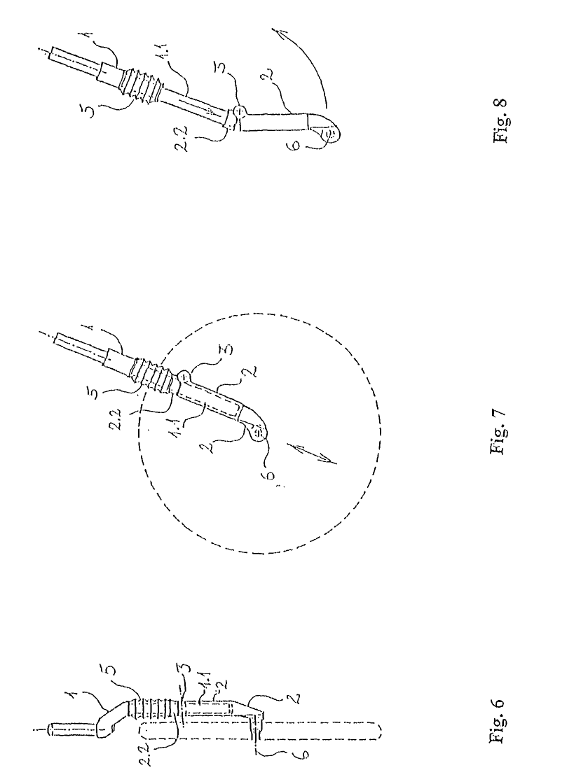

Example 2. A one-sided spring-loaded arm of the front wheel, which is shown in FIGS. 6 and 7, differs from the solution given in Example 1 in that part (2) with the pivot (3) mounted and with the auxiliary member (2.2) are mounted from the external side of part (1).

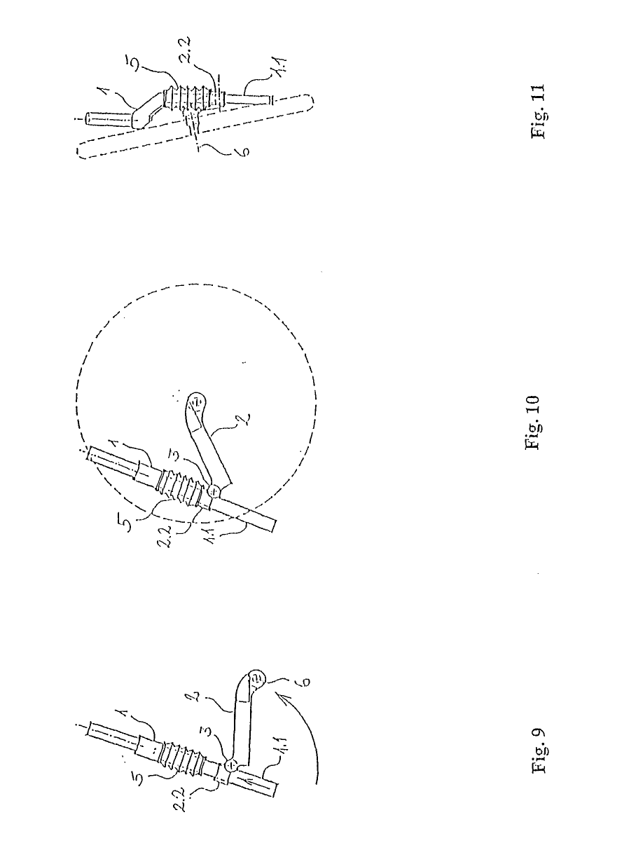

The pivot (3), which is mounted in this way, allows tilting part (2) together with the bicycle wheel to a lateral side of part (1), as shown in FIGS. 8 to 11. Unfolding of the spring-loaded arm is performed in a reversed way.

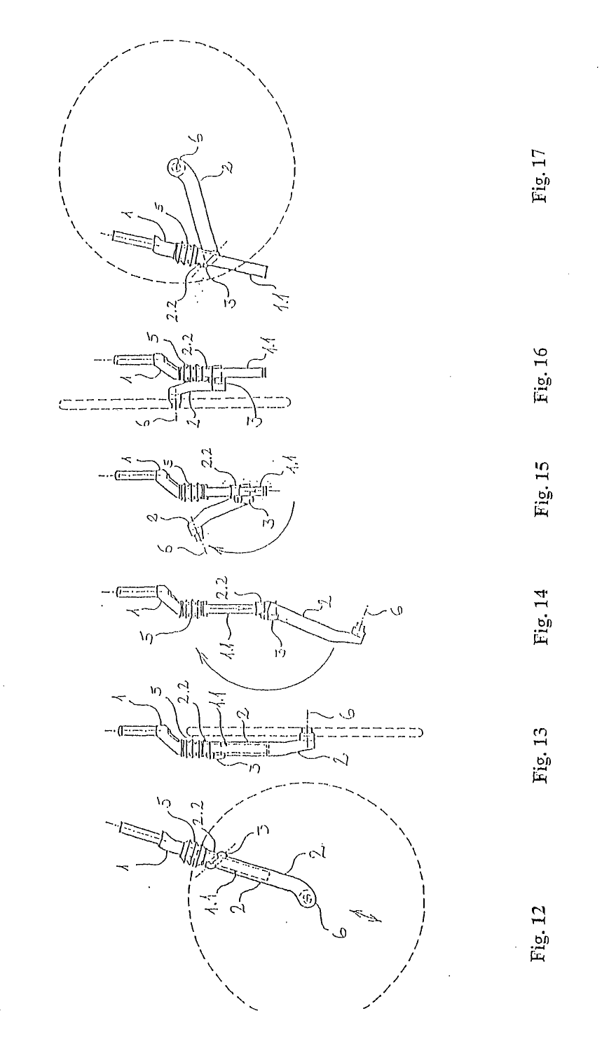

Example 3. A one-sided spring-loaded arm, which is shown in FIGS. 12 and 13, differs from the solution given in Example 2 in that the pivot (3) is mounted on a lateral side of (2) and it allows tilting the front wheel of the bicycle to a lateral side of part (1) just as in Example 2. Folding the one-sided spring-loaded arm is shown in FIGS. 14 to 17. The procedure of unfolding is reversed.

What is shown is a one-sided springing arm of the front wheel suitable for folding bicycles of any type, those from the bicycles for children to the bicycles for adults, also with classical wheel diameters, which are protected in PV 1621-99.

1. A one-sided spring-loaded arm for use with the front wheel of a bicycle, characterized in that it consists of first and second parts, of which one is spring-loaded, and further, the second part adapted to attach the front wheel of a bicycle and the first part adapted to be attached to the handlebar system of the bicycle, the second part joined with the first part slidingly in the direction of a longitudinal axis of the first part as well as pivotally around this axis, the second part fixable in position relative to the first part, the second part joined with the first part tiltably, with an axis of tilt lying in a plane transverse to the longitudinal axis of the first part.

2. The one-sided arm of claim 1, characterized in that the second part is spring-loaded and it comprises a telescopic part, which is terminated with a pivotally arranged auxiliary ember, while the telescopic part and the auxiliary member are slidingly and pivotally arranged and positionally fixable in a longitudinal opening in the first part.

3. The one-sided arm of claim 1, characterized in that the first part is spring-loaded and comprises a supporting part, on which there is an auxiliary member slidingly and pivotally arranged and positionally fixable, which is tiltably with a positional fixation connected with the second part while the supporting part is slidingly and pivotally and positionally fixable in the second part.

4. The one-sided arm of claim 2, characterized in that the tiltable connection between the auxiliary member and the second part is positionally fixable.

5. The one-sided arm of claim 3, characterized in that the tiltable connection between the auxiliary member and the second part is positionally fixable.
